(19) United States
(12) Patent Application Publication
(10) Pub. No.: US 2014/0186537 A1
(43) Pub. Date: Jul. 3, 2014

(54) METHOD FOR CONTROLLING A FLOW RATE OF A PUMP AND METHOD FOR FORMING A COATED FILM

(71) Applicant: Yoshinori Ikagawa, Okayama (JP)

(72) Inventor: Yoshinori Ikagawa, Okayama (JP)

(73) Assignee: TAZMO CO., LTD., Okayama (JP)

(21) Appl. No.: 14/119,309

(22) PCT Filed: May 25, 2012
(86) PCT No.: PCT/JP2012/063465

§ 371 Date: Nov. 21, 2013

(30) Foreign Application Priority Data
Jun. 1, 2011 (JP) 2011-123244

(51) Int. Cl. F04B 49/02; B05D 1/40

(52) U.S. Cl. CPC F04B 49/02; B05D 1/40
USPC 427/424; 417/53; 427/427.2

(57) ABSTRACT

A method for controlling a flow rate of a pump (10) transporting a liquid being driven by a drive system having a sliding portion, wherein a flow rate is maintained at a minute first flow rate (R1) at an early stage of operation of the pump (10); and subsequently the flow rate is increased to a steady second flow rate (R). With the method, at the early stage of operation of the pump (10), a state is established beforehand in which the pump (10) is kept stable at the minute first flow rate in order for the stick-slip phenomenon not to occur; and because the flow rate of the pump is increased from the state, transition from static friction to kinetic friction does not occur; and thus a disorderly flow rate of the pump (10) due to the stick-slip phenomenon of a motor (12) is suppressed.

This makes it possible to attain a stable control of the flow rate at the early stage of operation of the pump (10).

### TECHNICAL FIELD

The present invention relates to a method for controlling a flow rate of a pump transporting a liquid, and to a method for forming a coated film by discharging a coating compound transported by the pump onto a surface to be coated.

### BACKGROUND ART

Generally speaking, in positive displacement pumps such as piston pump, diaphragm pump and so forth used for liquid transportation, a minute stick-slip phenomenon occurs because of a sliding portion the pumps each have; so that a flow rate of such a pump is controlled by a motor such as a servomotor provided with a feedback mechanism in order to recover a time and/or a positional delay (for example, refer to Patent Literature 1).

FIG. 3 is a block diagram showing a general configuration of an example of such a diaphragm pump. The pump 10 comprises a main body 11, a linear motor 12, a piston 13, a diaphragm 14, a connecting block 16, a linear motor block 17 and a linear motor guide 18.

In one end face of the main body 11, a suction opening 11A and a discharge opening 11B are formed. On the other end face's side of the main body 11, the linear motor 12 is mounted. Inside the main body 11, a pressure chamber 11C and a power chamber 11D are formed. The pressure chamber 11C and the power chamber 11D are isolated from each other by the diaphragm 14 that is supported by the main body 11. The suction opening 11A and the discharge opening 11B communicate with the pressure chamber 11C. In the power chamber 11D, the linear motor guide 18 is located in an inner wall of the main body 11. On the linear motor guide 18, the linear motor block 17 is located so as to be slidable. The piston 13 is joined to the linear motor block 17 through the connecting block 16. To a surface of the diaphragm 14 on the power chamber 11D's side, a boss 14A is attached protrusively. A front end of the piston 13 is inserted into and fixed to the boss 14A.

With the configuration of the pump 10, when the linear motor 12 is driven, the piston 13 performs a reciprocating motion on a fixed straight track, with which the diaphragm 14 also performs a reciprocating motion together. This causes a pressure pulsation to occur in the pressure chamber 11C, and thereby a liquid sucked in from the suction opening 11A is discharged from the discharge opening 11B.

The linear motor 12 is provided with a feedback mechanism. In other words, an instruction section 20 controls the linear motor 12 through a control section 30, and a detecting device 40, upon examining a state of control, gives feedback to the control section 30. The control section 30, comparing a detected signal with a command signal (target value) and finding a difference if any in between, causes the linear motor 12 to operate toward a direction for decreasing the difference to the target value. In this manner, the difference to a target position is decreased. This procedure is repeated until the target value is finally reached, or until the difference comes within an acceptable range.

As shown in FIG. 4A, a case is contemplated in which the command signal is null up to a time T1 for which the pump 10 is kept on standby, in which at the time T1 the command signal is increased linearly from zero until a steady value S is reached at a time T2 (T2>T1), and in which thereafter the command signal is kept at the steady value.

With the above described configuration of the pump 10, because the linear motor block 17 slides along the linear motor guide 18, the stick-slip phenomenon occurs at its sliding portion F at a very early stage of transition from static friction to kinetic friction. That is to say, the detected signal indicating an actually moving state of the linear motor 12 cannot follow the command signal, and starts increasing a little late from a time T1′ (T1′>T1). This results in a difference between the detected signal and the target value. The above-mentioned feedback mechanism controls the linear motor 12 so as to decrease the difference.

However, a drawback as well as manner of the control peculiar to the feedback mechanism as it is, the signal gains acceleration for the attainment of a quick recovery from shortage; so that after the detected signal reaches a target value at a time TA (T1<TA<T2) influence of the acceleration does not stop abruptly, thereby causing an overshoot as illustrated. Then, the feedback mechanism functions toward the opposite direction in order to compensate for the excess. Accordingly, it takes some time TB (TA<TB<T2) for the difference to converge in the vicinity of zero.

In this manner, the operation of the linear motor 12 while the feedback mechanism is functioning also influences the flow rate of the pump 10. In other words, in an example of FIG. 4B, the flow rate is less than the ideal flow rate in the period between the time T1 and the time TA, whereas the flow rate becomes larger than the ideal flow rate in the period between the time TA and the time TB. That is, the flow rate of the pump 10 becomes disorderly and unsteady at least in the period between the time T1 and the time TB. Particularly, in applications where the flow rate of the pump 10 has a direct influence on the quality of products, for example, in an application where solid concentration is so high that the shape of a liquid film just influences that of a dry film, in another application where a thin film of a thickness not greater than 100 nm is to be formed uniformly on a substrate and so forth, the film thickness is uncontrollable at the early stage of operation of the pump 10, from which a problem arises that an area on a substrate to which a coating has been applied cannot be made efficient use of.

### CITATION LIST

### Patent Literature

### Patent Literature 1

Japanese Patent Unexamined Publication No. 2005-76492 bulletin

### SUMMARY OF INVENTION

### Technical Problem

A embodiment of the claimed invention was contrived to solve the above-mentioned technical problem, and is directed to attaining a stable control of a flow rate at an early stage of operation of a pump.

### Solution to Problem

A method for controlling a flow rate of a pump according to the present invention is a method for controlling a flow rate of a pump transporting a liquid being driven by a drive system having a sliding portion, wherein a flow rate is maintained at a minute first flow rate at an early stage of operation of the pump; and subsequently the flow rate is increased to a steady second flow rate.

With the method, at the early stage of operation of the pump, a state is established beforehand in which the pump is kept stable at the minute first flow rate in order for the stick-slip phenomenon not to occur; and because the flow rate of the pump is increased from the state, transition from static friction to kinetic friction does not occur; and thus a disorderly flow rate of the pump due to the stick-slip phenomenon of a motor is suppressed. This makes it possible to attain a stable control of the flow rate at the early stage of operation of the pump. For example, it is possible to attain a control that causes the flow rate to increase linearly from the first flow rate to the second flow rate. Additionally, influence of the instability of the discharged flow rate on a film that is caused by the stick-slip phenomenon occurring when the pump discharges the flow from a halted state to the first flow rate can be suppressed to a minimal degree because the first flow rate is infinitesimal.

Further, a method for forming a coated film according to the present invention is a method for forming a coated film using a pump of which flow rate is controlled by the above method and a nozzle head discharging a coating compound transported by the pump, wherein a liquid puddle of the coating compound is formed between the nozzle head and a flat surface to be coated by discharging the coating compound from the nozzle head continuously with the nozzle head being brought in close proximity to the surface to be coated; and the liquid puddle of the coating compound is moved relatively on the surface to be coated by moving the surface to be coated horizontally.

This results in the formation of the coated film of the coating compound on the surface to be coated following a moving trail of the coating compound that is discharged from the nozzle head. A thickness of the coated film can be controlled by synchronizing a travel rate of the surface to be coated with the flow rate of the pump. In concrete terms, the film thickness can be made uniform by establishing a linear relationship between the travel rate of the surface to be coated and the flow rate of the pump.

In addition, instead of moving the surface to be coated horizontally, the nozzle head may be moved horizontally above the surface to be coated with the nozzle head being supported by a movable support member. This also makes it possible to move the liquid puddle of the coating compound on the surface to be coated, and thus to form a coated film equally.

### Advantageous Effects of Invention

The present invention makes it possible to stabilize a flow rate at an early stage of operation of a pump.

### BRIEF DESCRIPTION OF DRAWINGS

FIG. 1A is a drawing showing an example of a variation in time of a command signal for driving a motor and a detected signal at an early stage of operation of a pump by a method according to the present invention.

FIG. 1B is a drawing showing a variation in time of a flow rate at the early stage of operation of the pump by the method according to the present invention.

FIG. 2 is a timing chart showing an example of a flow rate control on the pump and coating speed control according to the present invention.

FIG. 3 is a block diagram showing an example of a general configuration of a diaphragm pump.

FIG. 4A is a drawing showing an example of a variation in time of a command signal for driving a motor and a detected signal at an early stage of operation of a pump by a conventional method.

FIG. 4B is a drawing showing a variation in time of a flow rate at the early stage of operation of the pump by the conventional method.

### DESCRIPTION OF EMBODIMENTS

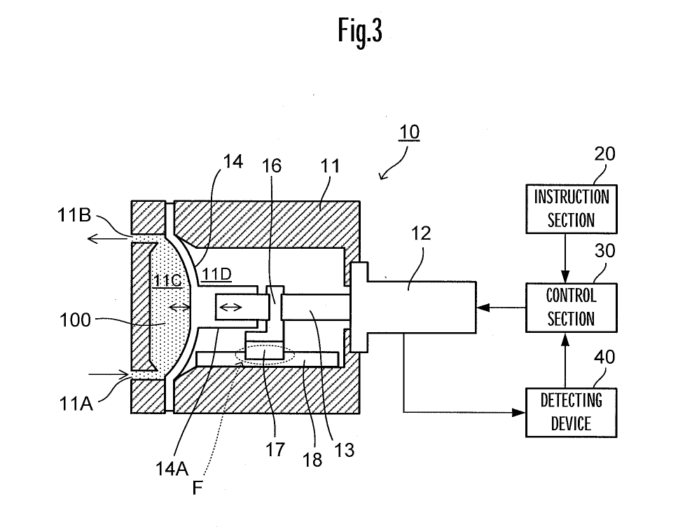

A method for controlling a flow rate of a pump according to an embodiment of the present invention is explained below, referring to the drawings. In the following description, a case of using a diaphragm pump having a configuration similar to the one in FIG. 3 is explained, as an example of a positive displacement pump. However, a pump to which the present invention is applied is not limited to a diaphragm pump. For example, it is also applicable to pumps such as piston pump and so forth in which the stick-slip phenomenon can occur.

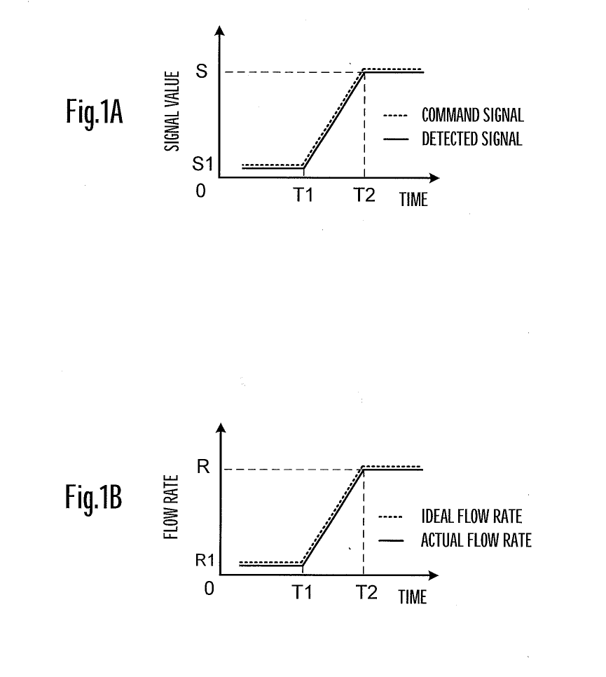

According to the present invention, as shown in FIG. 1A, a detected signal is made to agree with a command signal by giving a command signal of a minute predetermined signal value S1 beforehand before a time T1 is reached for which a linear motor 12 is kept on standby. That is to say, being brought into a warm-up drive by the minute input, the linear motor 12 is kept beforehand in a state where the stick-slip phenomenon does not occur, i.e. a state in which a disorderly flow rate of the pump due to a feedback control is suppressed with a kinetic friction force acting on the pump. This provides a condition that allows the detected signal to follow the command signal at the time T1.

Then, from the time T1 to the time T2, the command signal is increased linearly to a steady value S, at which the command signal is maintained thereafter. Now that the detected signal is ready to follow the command signal, the linear motor 12 is driven exactly following the command signal.

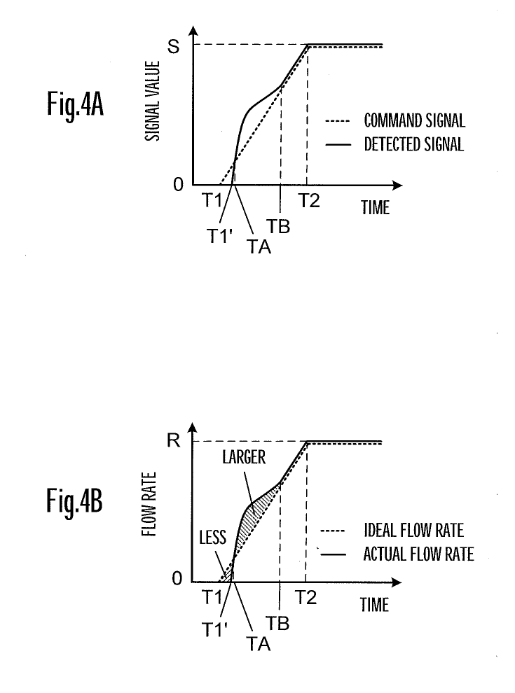

As a result, as shown in FIG. 1B, also the flow rate of the pump 10 is stable at a minute first flow rate R1 at the time T1, then increases linearly from the time T1 to the time T2, and is maintained thereafter at a second flow rate R which is a steady flow rate. Accordingly, it is made possible for the flow rate of the pump 10 after the time T1 to be completely kept under control, and thus it is made possible for the flow rate to be controlled stably even within the time zone (refer to the time T1 through TB in FIG. 4) in which it was not possible to control the flow rate conventionally.

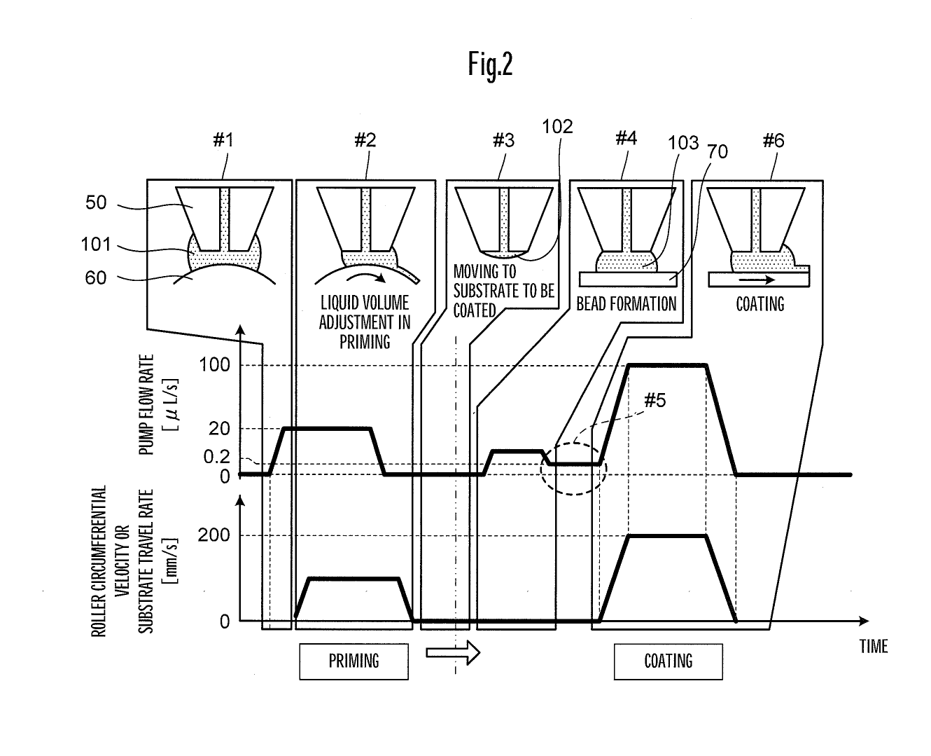

Conversely, it may be said that the flow rate up to the time T1 is not controlled; however, the liquid transported during the period is too small in amount to have much influence on its liquid consumption. In addition, in a film-forming application as will be mentioned later, this period of time corresponds to a stage (refer to a step #4 in FIG. 2) at which a liquid puddle referred to as a bead that has been formed on a surface to be coated is retained; so that the liquid is used for an effective coated film instead of being wasted.

The above-mentioned method for controlling a flow rate of a pump of the embodiment of the claimed invention is effective for an application in which the flow rate of the pump has a direct influence on the quality of products, for example, an application in which a coated film of a thickness not greater than 10 μm is to be formed uniformly on a substrate.

In the following, using FIG. 2, a method for forming a coated film using a pump of which flow rate is controlled by a method according to the present invention and a nozzle head discharging a coating compound in liquid state that is transported by the pump is explained. FIG. 2 is a timing chart showing an example of a flow rate control of the pump and coating speed control in the method for forming a coated film.

First, a preparation process called priming is carried out in order to remove bubbles inside the nozzle head 50 and to adjust a liquid volume. In the priming, the pump 10 is operated in order for the flow rate of the pump to be increased linearly from zero up to a predetermined priming flow rate (20 μL/s in FIG. 2), and then the coating compound is discharged slowly from the nozzle head 50 onto a surface of a stationary priming roller 60 (step #1). This causes the bubbles in the nozzle head 50 to be expelled, and a ball-shaped liquid puddle 101 wrapping a tip portion of the nozzle head 50 in is formed on the surface of the priming roller 60.

Then, by rotating the priming roller 60 for a predetermined period of time, the liquid volume is adjusted (step #2). During this time, the operation of the pump 10 is controlled in such a manner that after the flow rate of the pump has been maintained at the above described priming flow rate the flow rate is decreased linearly to zero, and that the flow rate is then halted by the time when the rotation of the priming roller 60 stops. At the time when the rotation of the priming roller 60 stops, discharge of the coating compound stops; and then a droplet 102 is formed on a tip surface of the nozzle head 50 due to the surface tension.

Then, the nozzle head 50 retaining the droplet 102 on the tip is moved to above the substrate 70 (step #3). The tip of the nozzle head 50 is brought in close proximity to the surface to be coated of the substrate 70; and in a noncontact state with a predetermined gap maintained in between, the nozzle head 50 is fixed at a fixed position. It is postulated that the substrate 70 is placed on a horizontally movable stage (not shown).

Then, by discharging the coating compound continuously from the nozzle head 50 with the pump 10 being operated, a liquid puddle 103 of the coating compound that is referred to as a bead is formed (step #4). During this time, the movable stage is kept on being halted, and the pump 10 is controlled in such a manner that the flow rate of the pump 10 is increased linearly from zero to a preliminary flow rate for forming the liquid puddle 103, that the flow rate of the pump 10 is then maintained at the preliminary flow rate, and that the flow rate of the pump 10 is thereafter decreased linearly. On this occasion, in order to switch over to the above-mentioned control that is characteristic of the embodiment of the claimed invention, a target value for a flow rate to which to decrease is set at a minute first flow rate (0.2 μL/s in FIG. 2) instead of being set at zero, as shown.

Then, in order to maintain the flow rate of the pump at the minute first flow rate, the operation of the pump 10 is maintained (step #5). Because the first flow rate is infinitesimal as small as being 0.2% of the second flow rate (100 μL/s in FIG. 2) which is a steady flow rate, the coating compound discharged during this time is of an extremely small amount which does not give cause for concern about processing cost.

After that, a coating (forming a coated film) is carried out by operating the pump 10 and the movable stage at the same time (step #6). At this time, the operation of the pump 10 is controlled in such a manner that the flow rate of the pump is increased linearly from the first flow rate to the second flow rate (100 μL/s in FIG. 2) which is a steady flow rate, and that after having been maintained at the steady flow rate the flow rate of the pump is then decreased linearly to zero. This ensures that a disorderly flow rate of the pump due to the stick-slip phenomenon of the motor does not occur at an early stage of a coating process. Thus, it is made possible to control the flow rate of the pump stably during the coating process.

In the coating process (step #6), the movable stage is operated to move the substrate 70 horizontally. This causes the liquid puddle 103 to move on the surface to be coated of the substrate 70, and then a coated film is formed following a moving trail of the liquid puddle 103. On this occasion, the thickness of the coated film formed on the substrate 70 depends on both of the parameters, i.e. the flow rate of the pump 10 and the travel rate of the substrate 70. As described above, because the flow rate of the pump 10 is kept under control, control of the film thickness is made possible by controlling the travel rate of the substrate 70 so as to be synchronized with the change of the flow rate of the pump 10. For example, in order to obtain a uniform film thickness, the travel rate of the substrate 70 should be made small if the flow rate of the pump 10 is small, and the travel rate of the substrate 70 should be made large if the flow rate of the pump 10 is large.

In the embodiment, the operation of the movable stage is controlled so that a linear relationship applies between the both by synchronizing the travel rate of the substrate 70 with the flow rate of the pump 10. In concrete terms, as illustrated, the operation of the movable stage is controlled in such a manner that the travel rate of the substrate 70 is increased linearly from zero to a predetermined speed during a period of time when the flow rate of the pump is increased linearly from the first flow rate to the second flow rate, that the travel rate of the substrate 70 is maintained at the predetermined speed during a period of time when the flow rate of the pump is maintained at a steady flow rate, and that the travel rate of the substrate 70 is decreased linearly from the predetermined speed to zero during a period of time when the flow rate of the pump is decreased linearly from the steady flow rate to zero. This enables the thickness of the coated film to be controlled uniformly during the coating process.

Further, although, in the above-mentioned embodiment, the liquid puddle 103 of the coating compound is relatively moved on the surface to be coated by moving the substrate 70 horizontally being placed on the movable stage, the nozzle head 50 may be moved horizontally above the surface to be coated with the nozzle head 50 being supported on a movable support member. This also makes it possible to move the liquid puddle 103 of the coating compound on the surface to be coated, and thus to form the coated film equally.

The above explanation of the embodiment is nothing more than illustrative in any respect, nor should be thought of as restrictive. Scope of the present invention is indicated by claims rather than the above embodiment. Further, it is intended that all changes that are equivalent to a claim in the sense and realm of the doctrine of equivalence be included within the scope of the present invention.

### Industrial Applicability

The present invention is of use to applications in which a flow rate of a pump directly influences quality of products, for example, to applications such as medical fluid injection, painting, thin film formation (for example, a coated film of a thickness not greater than 100 nm to be formed uniformly on a substrate) and so forth.

### REFERENCE SIGNS LIST

10—Pump

20—Instruction section

30—Control section

40—Detecting device

50—Nozzle head

60—Priming roller

70—Substrate

103—Liquid puddle of a coating compound

1. A method for controlling a flow rate of a pump transporting a liquid being driven by a drive system having a sliding portion, wherein
a disorderly flow rate due to a friction force acting on the sliding portion when the pump switches over from a halted state to an operating state is suppressed by maintaining a flow rate at a minute first flow rate at an early stage of operation of the pump and subsequently increasing the flow rate to a second steady flow rate.

2. A method for forming a coated film using the pump of which flow rate is controlled by the method as claimed in claim 1 and a nozzle head discharging a coating compound transported by the pump, wherein
with the nozzle head being brought in close proximity to a flat surface to be coated a liquid puddle of the coating compound is formed between the nozzle head and the surface to be coated by discharging the coating compound continuously from the nozzle head; and
the liquid puddle of the coating compound is relatively moved on the surface to be coated by moving the surface to be coated horizontally.

3. The method for forming a coated film as claimed in claim 2, wherein a travel rate of the surface to be coated is synchronized with the flow rate of the pump.

4. A method for forming a coated film using the pump of which flow rate is controlled by the method as claimed in claim 1 and a nozzle head discharging a coating compound transported by the pump, wherein
with the nozzle head being brought in close proximity to a flat surface to be coated a liquid puddle of the coating compound is formed between the nozzle head and the surface to be coated by discharging the coating compound continuously from the nozzle head; and
the liquid puddle of the coating compound is moved on the surface to be coated by moving the nozzle head horizontally above the surface to be coated.

5. The method for forming a coated film as claimed in claim 4, wherein a travel rate of the nozzle head is synchronized with the flow rate of the pump.
